(19) United States
(12) Patent Application Publication
(10) Pub. No.: US 2026/0003218 A1
(43) Pub. Date: Jan. 1, 2026

(54) LIGHT PATH CONTROL MEMBER AND DISPLAY DEVICE COMPRISING SAME

(71) Applicant: LG INNOTEK CO., LTD., Seoul (KR)

(72) Inventors: Chan Mi JU, Seoul (KR); Jin Gyeong PARK, Seoul (KR); Byung Sook KIM, Seoul (KR)

(21) Appl. No.: 18/879,673

(22) PCT Filed: May 15, 2023
(86) PCT No.: PCT/KR2023/006555

§ 371 Date: Dec. 27, 2024

(30) Foreign Application Priority Data
Jun. 27, 2022 (KR) 10-2022-0078342

(51) Int. Cl. G02F 1/13; G02F 1/166

(52) U.S. Cl. CPC G02F 1/1323; G02F 1/166

(57) ABSTRACT

A light path control member according to an embodiment includes a first substrate; a first electrode disposed on the first substrate; a second substrate disposed on the first substrate; a second electrode disposed under the second substrate; and a light conversion part disposed between the first electrode and the second electrode, wherein the light conversion part includes a partition wall part and a receiving part which are alternately disposed, a light conversion material is disposed inside the receiving part, and a first coating layer is disposed on an inner surface of the receiving part.

### TECHNICAL FIELD

An embodiment relates to a light path control member and a display device including the same.

### BACKGROUND ART

A light blocking film blocks light from being transmitted from a light source. The light blocking film is attached to a front of a display panel, which is a display device used for a mobile phone, laptop, tablet PC, vehicle navigation, or vehicle touch screen. The light blocking film adjusts a viewing angle of light according to an angle of incidence of light when the display outputs a screen. As a result, the user can view clear image quality at the desired viewing angle.

In addition, light blocking film is used for windows in vehicles or buildings. Accordingly, the light blocking film can prevent glare by partially shielding external light. Alternatively, the light blocking film can make an inside invisible from an outside.

That is, the light blocking film controls a movement path of light. As a result, the light blocking film blocks light from a specific direction and transmits light from another specific direction. That is, the light blocking film may be a light path control member. Accordingly, since an angle of light transmission is controlled by the light blocking film, the user's viewing angle can be controlled.

Meanwhile, the light blocking film can be divided into a light blocking film that can always control the viewing angle regardless of a surrounding environment, and a switchable light blocking film that allows the user to turn the viewing angle control on and off depending on the surrounding environment.

The switchable light blocking film includes a receiving part. A light conversion material is disposed inside the receiving part. The light conversion material includes particles and a dispersion liquid in which the particles are dispersed. The particles can move by applying voltage. Accordingly, the receiving part can be switched into a light transmitting portion or a light blocking portion.

Meanwhile, the receiving part can be formed by patterning a concave portion on a resin material. In addition, the light conversion material can be disposed inside the receiving part.

Accordingly, the light conversion material comes into contact with the resin material. Accordingly, an additive of the resin material can be introduced into the light conversion material. Accordingly, characteristics of the light conversion material can be changed. Accordingly, driving characteristics of the light path control member can be reduced.

In addition, during a process of manufacturing the light blocking film, the resin material can be deformed by heat. Alternatively, the resin material may be deformed by heat in an environment in which the light blocking film is being used. As a result, the reliability of the optical path control member may be reduced.

Therefore, a new light path control member having a structure that can solve the above problems is required.

### DISCLOSURE

### Technical Problem

An embodiment provides a light path control member having improved driving characteristics and reliability.

### Technical Solution

A light path control member according to an embodiment includes a first substrate; a first electrode disposed on the first substrate; a second substrate disposed on the first substrate; a second electrode disposed under the second substrate; and a light conversion part disposed between the first electrode and the second electrode, wherein the light conversion part includes a partition wall part and a receiving part which are alternately disposed, a light conversion material is disposed inside the receiving part, and a first coating layer is disposed on an inner surface of the receiving part.

### Advantageous Effects

The light path control member according to the embodiment includes a coating layer. In detail, the light path control member according to the embodiment includes at least one coating layer among a first coating layer, a second coating layer, and a third coating layer.

The light path control member can prevent a decrease in driving characteristics by the coating layer. A light conversion material and a partition wall part do not come into direct contact by the coating layer. In addition, the light conversion material and a base part do not come into direct contact by the coating layer. Therefore, impurities of the partition wall part or the base part do not flow into the light conversion material.

In addition, a reliability of the light path control member is improved by the coating layer. The coating layer has a thickness and a decomposition temperature within a set range. Accordingly, a shape of the light path control member can be fixed by the coating layer. Therefore, a shape of the light conversion part does not change due to heat generated during driving of the light path control member.

In addition, adhesion characteristics of the second electrode and the light conversion part are improved by the coating layer. That is, a surface of the light conversion part in contact with the adhesive layer is flattened. In addition, an area of the coating layer in contact with the adhesive layer is increased. Accordingly, the adhesive characteristics of the adhesive layer are improved.

### DESCRIPTION OF DRAWINGS

FIG. 1 is a perspective view of a light path control member according to an embodiment.

FIGS. 2 and 3 are cross-sectional views taken along line A-A′ of FIG. 1.

FIGS. 4 to 6 are cross-sectional views taken along line A-A′ of FIG. 1 according to an embodiment.

FIGS. 7 and 8 are cross-sectional views of a display device to which a light path control member according to an embodiment is applied.

FIGS. 9 to 11 are drawings for explaining an embodiment of a display device to which a light path control member according to an embodiment is applied.

### MODE FOR INVENTION

Hereinafter, embodiments of the present disclosure will be described in detail with reference to the accompanying drawings. However, the spirit and scope of the present disclosure is not limited to a part of the embodiments described, and may be implemented in various other forms, and within the spirit and scope of the present disclosure, one or more of the elements of the embodiments may be selectively combined and redisposed.

In addition, unless expressly otherwise defined and described, the terms used in the embodiments of the present disclosure (including technical and scientific terms) may be construed the same meaning as commonly understood by one of ordinary skill in the art to which the present disclosure belongs, and the terms such as those defined in commonly used dictionaries may be interpreted as having a meaning that is consistent with their meaning in the context of the relevant art.

In addition, the terms used in the embodiments of the present disclosure are for describing the embodiments and are not intended to limit the present disclosure. In this specification, the singular forms may also include the plural forms unless specifically stated in the phrase, and may include at least one of all combinations that may be combined in A, B, and C when described in “at least one (or more) of A (and), B, and C”.

Further, in describing the elements of the embodiments of the present disclosure, the terms such as first, second, A, B, (a), and (b) may be used. These terms are only used to distinguish the elements from other elements, and the terms are not limited to the essence, order, or order of the elements.

In addition, when an element is described as being “connected”, “coupled”, or “contacted” to another element, it may include not only when the element is directly “connected” to, “coupled” to, or “contacted” to other elements, but also when the element is “connected”, “coupled”, or “contacted” by another element between the element and other elements.

In addition, when described as being formed or disposed “on (over)” or “under (below)” of each element, the “on (over)” or “under (below)” may include not only when two elements are directly connected to each other, but also when one or more other elements are formed or disposed between two elements.

Further, when expressed as “on (over)” or “under (below)”, it may include not only the upper direction but also the lower direction based on one element.

Hereinafter, a light path control member according to an embodiment will be described with reference to the drawings. The light path control member described hereinafter may be a switchable light blocking film that is driven in a share mode or a light blocking mode according to an application of power.

FIG. 1 is a perspective view of a light path control member according to an embodiment.

Referring to FIG. 1, a light path control member 1000 according to an embodiment includes a first substrate 110, a second substrate 120, a first electrode 210, a second electrode 220, and a light conversion part 300.

The first substrate 110 and the second substrate 120 may be rigid or flexible.

In addition, the first substrate 110 and the second substrate 120 may be transparent. For example, the first substrate 110 and the second substrate 120 may include a transparent substrate capable of transmitting light.

The first substrate 110 and the second substrate 120 may include glass, plastic, or a flexible polymer film. For example, the flexible polymer film may include polyethylene terephthalate (PET), polycarbonate (PC), acrylonitrile-butadiene-styrene copolymer (ABS), polymethyl methacrylate (PMMA), polyethylene naphthalate (PEN), polyether sulfone (PES), cyclic olefin copolymer (COC), triacetylcellulose (TAC) film, polyvinyl alcohol (PVA) film, polyimide (PI) film, or polystyrene (PS).

In addition, the first substrate 110 and the second substrate 120 may be flexible substrates having flexible characteristics.

In addition, the first substrate 110 and the second substrate 120 may be curved or bent substrates. Accordingly, the light path control member may have flexible, curved or bent characteristics. Therefore, the light path control member according to the embodiment may be changed into various designs.

The first substrate 110 and the second substrate 120 may have a thickness within a set range. For example, the thickness of the first substrate 100 and the thickness of the second substrate 120 may be 30 um to 100 um. In detail, the thickness of the first substrate 110 and the thickness of the second substrate 120 may be 40 um to 80 um. More specifically, the thickness of the first substrate 110 and the thickness of the second substrate 120 may be 50 um to 60 um.

If the thickness of the first substrate 110 and the thickness of the second substrate 120 exceed 100 um, an overall thickness and weight of the light path control member may increase.

In addition, if the thickness of the first substrate 110 and the thickness of the second substrate 120 are less than 30 um, an electrode is not sufficiently supported by the first substrate 110 and the second substrate 120.

The thickness of the first substrate 110 and the thickness of the second substrate 120 may be the same or similar within the above range.

The first electrode 210 and the second electrode 220 may include a transparent conductive material. For example, the first electrode 210 and the second electrode 220 may include a conductive material having a light transmittance of about 80% or more. For example, the first electrode 210 and the second electrode 220 may include a metal oxide. For example, the first electrode 210 and the second electrode 220 may include indium tin oxide, indium zinc oxide, copper oxide, tin oxide, zinc oxide, or titanium oxide.

Alternatively, the first electrode 210 and the second electrode 220 may include various metals to implement a small resistance. For example, the first electrode 210 and the second electrode 220 may include at least one metal among chromium (Cr), nickel (Ni), copper (Cu), aluminum (Al), silver (Ag), molybdenum (Mo), gold (Au), titanium (Ti), and alloys thereof.

The first electrode 210 and the second electrode 220 may have a thickness within a set range. For example, a thickness of the first electrode 210 and a thickness of the second electrode 220 may be 0.2 um to 1 um. In detail, the thickness of the first electrode 210 and the thickness of the second electrode 220 may be 0.2 um to 0.5 um.

If the thickness of the first electrode 210 and the thickness of the second electrode exceed 1 um, the overall thickness and weight of the light path control member may increase.

In addition, if the thickness of the first electrode 210 and the thickness of the second electrode 220 are less than 0.2 um, the thickness of the first electrode 210 and the resistance of the second electrode 220 may increase. By this, the driving characteristics of the light path control member can be reduced.

The thickness of the first electrode 210 and the thickness of the second electrode 220 can be the same or similar within the above range.

A connection electrode is disposed on each of the first substrate 110 and the second substrate 120. The connection electrode includes a first connection electrode CA1 and a second connection electrode CA2. The first connection electrode CA1 is formed by exposing the first electrode 210 on the first substrate 110. The second connection electrode CA2 is formed by exposing the second electrode 220 on the second substrate 120.

The light path control member is electrically connected to an external (flexible) printed circuit board by the first connection electrode CA1 and the second connection region CA2.

For example, a pad part may be disposed on the first connection electrode CA1 and the second connection electrode CA2. A conductive adhesive may be disposed between the pad part and the (flexible) printed circuit board. The conductive adhesive may include an anisotropic conductive film (ACF) or anisotropic conductive paste (ACP). Accordingly, the pad part and the (flexible) printed circuit board may be connected.

Alternatively, the conductive adhesive may be disposed between the connection electrodes CA1 and CA2 and the (flexible) printed circuit board. Accordingly, the pad part and the (flexible) printed circuit board may be connected without a separate pad part.

The light conversion part 300 is disposed between the first substrate 110 and the second substrate 120. In detail, the light conversion part 300 is disposed between the first electrode 210 and the second electrode 220.

A buffer layer 410 is disposed between the light conversion part 300 and the first electrode 210. The buffer layer 410 improves an adhesion between the first electrode 220 and the light conversion part 300, which is a heterogeneous material. That is, the buffer layer 410 may be a primer layer disposed between the light conversion part 300 and the first electrode 210.

An adhesive layer 420 is disposed between the light conversion part 300 and the second electrode 220. The light conversion part 300 and the second electrode 220 can be adhered by the adhesive layer 420.

The buffer layer 410 and the adhesive layer 420 can include a transparent material capable of transmitting light. For example, the buffer layer 410 can include a transparent resin. In addition, the adhesive layer 420 can include an optically transparent adhesive (OCA).

The light path control member can extend in a first direction 1D, a second direction 2D, and a third direction 3D.

The first direction 1D corresponds to a length or width direction of the light path control member. The second direction 2D corresponds to a length or width direction of the light path control member. The second direction 2D is different from the first direction 1D. The third direction 3D corresponds to a thickness direction of the light path control member. The third direction 3D is different from the first direction 1D and the second direction 2D.

For example, the first direction 1D may be defined in the length direction of the light path control member. In addition, the second direction 2D may be defined in the width direction of the light path control member. In addition, the third direction 3D may be defined in the thickness direction of the light path control member.

Alternatively, the first direction 1D may be defined in the width direction of the light path control member. In addition, the second direction 2D may be defined in the length direction of the light path control member. In addition, the third direction 3D may be defined in the thickness direction of the light path control member.

Hereinafter, for convenience of explanation, the first direction 1D is defined as the length direction of the light path control member. In addition, the second direction 2D is defined as the width direction of the light path control member. In addition, the third direction 3D is defined as the thickness direction of the light path control member.

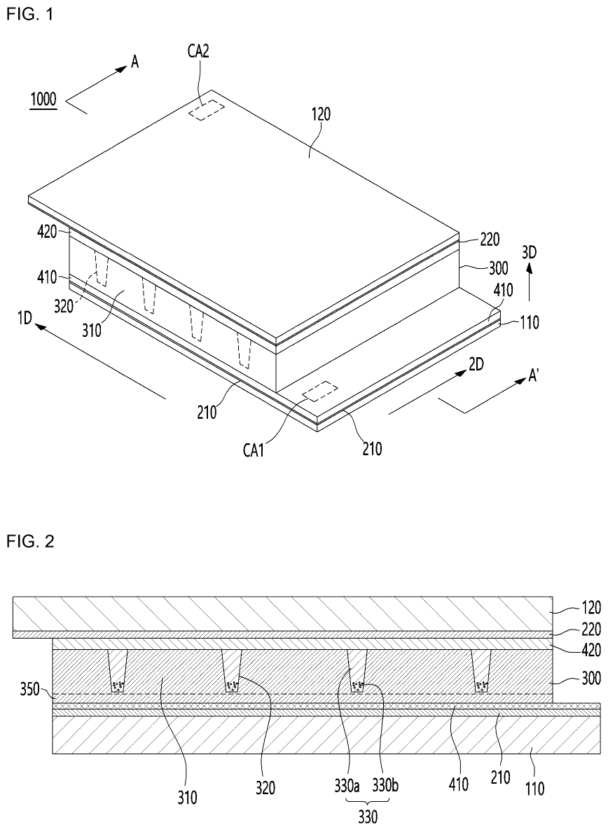

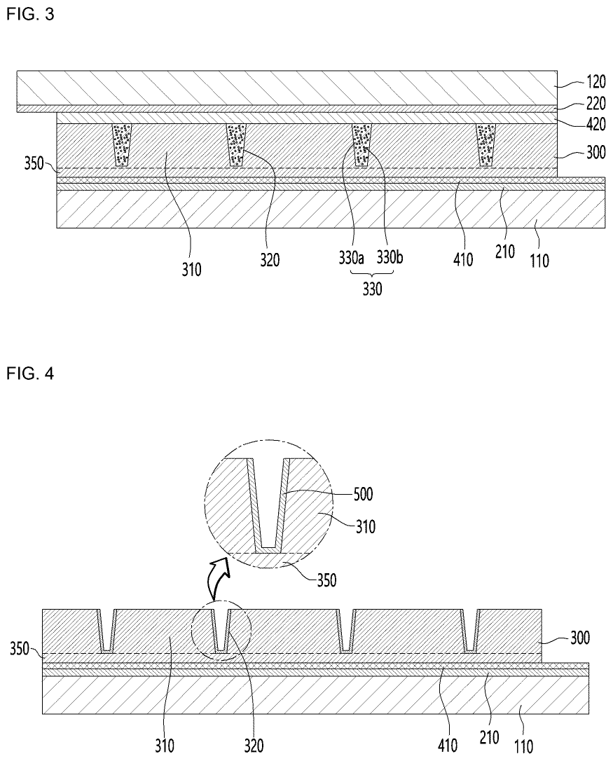

FIGS. 2 and 3 are cross-sectional views taken along line A-A′ of FIG. 1.

Referring to FIG. 2 and FIG. 3, the light conversion part 300 includes a plurality of partition wall parts 310, a plurality of receiving parts 320, and a base part 350.

The partition wall parts 310 and the receiving parts 320 are disposed alternately. That is, one receiving part 320 is disposed between two adjacent partition wall parts 310. In addition, one partition wall part 310 is disposed between two adjacent receiving parts 320.

The base part 350 is disposed below the receiving part 320. In detail, the base part 350 is disposed between the receiving part 320 and the buffer layer 410. More specifically, the base part 350 is disposed between a lower surface of the receiving part 320 and an upper surface of the buffer layer 410. Accordingly, the light conversion part 300 is adhered to the first electrode 210 by the base part 350 and the buffer layer 410.

In addition, an adhesive layer 420 is disposed between the partition wall part 310 and the second electrode 220. The light conversion part 300 and the second electrode 220 are adhered by the adhesive layer 420.

The partition wall part 310 and the receiving part 320 include a resin material. A mold member is imprinted on the resin material. The base part 350 is formed while the mold member is released. Accordingly, the base part 350 and the partition wall part 310 include a same material. That is, the base part 350 and the partition wall part 310 are formed integrally.

The base part 350 may have a thickness within a set range. For example, a thickness of the base part 350 may be 10% or less of a thickness of the light conversion part. In detail, the thickness of the base part 350 may be 5% to 10% of the thickness of the light conversion part. In detail, the thickness of the base part 350 may be 6% to 9% of the thickness of the light conversion part.

If the thickness of the base part 350 exceeds 10% of the thickness of the light conversion part, a distance between the receiving part 320 and the first electrode 210 increases. Accordingly, a voltage applied to the receiving part may decrease. Accordingly, driving characteristics of the light path control member may decrease.

The resin material may include a resin composition. The resin composition may include an oligomer, a monomer, a photopolymerization initiator, and an additive. A prepolymer in a high molecular form and a multifunctional monomer and a photopolymerization initiator as a diluent react. The resin composition is cured by the reaction to form a resin layer. An intaglio portion in a shape of the receiving part is formed in the resin layer. Accordingly, the partition wall part 310, the receiving part, and the base part 350 are formed.

The partition wall part 310 can transmit light. In addition, the receiving part 320 can change the light transmittance according to application of voltage.

A light conversion material 330 is disposed inside the receiving part 320. The light transmittance of the receiving part 320 can change by the light conversion material 330. The light conversion material 330 includes light conversion particles 330b and a dispersion liquid 330a dispersing the light conversion particles 330b. The light conversion particles 330b move by the voltage application. In addition, the light conversion material 300 can further include a dispersant. The dispersant can prevent aggregation of the light conversion particles 330b.

The light conversion particles 330b move by the voltage application. Referring to FIG. 2, surfaces of the light conversion particles 330b are negatively charged. When a positive voltage is applied to the first electrode 210 and the second electrode 220, the light conversion particles 330b move toward the first electrode 210 or the second electrode 220. Thereby, the receiving part 320 becomes a light transmitting portion.

Referring to FIG. 3, when a negative voltage is applied to the first electrode 210 and the second electrode 220, the light conversion particles 330b are dispersed again into the dispersion 330a. Thereby, the receiving part 320 becomes a light blocking portion.

In addition, when no voltage is applied to the first electrode 210 and the second electrode 220, the light conversion particles 330b are dispersed inside the dispersion 330a. Thereby, the receiving part 320 maintains a state of the light blocking portion.

As described above, the light conversion part 300 includes a resin composition. That is, the light conversion part 300 includes a resin layer that is cured by the resin composition.

The resin composition includes a photo initiator and at least one additive. After forming the light conversion part 300, the photo initiator and the additive may remain in the partition wall part 310 and the base part 350.

The light conversion material 330 inside the receiving part 320 comes into contact with the partition wall part 310. Accordingly, the photo initiator or additive of the partition wall part 310 may flow into the inside of the light conversion material while the light path control member is being driven. Accordingly, characteristics of the light conversion material may change. Accordingly, driving characteristics of the light path control member may decrease.

In addition, since the partition wall part 310 is formed by a resin composition, a shape of the partition wall part may change due to an increase in temperature. That is, when heat exceeding a set range is applied to the partition wall part 310, a shape of the partition wall part may change. Accordingly, a transmittance of light passing through the partition wall part 310 may change.

Therefore, a light path control member that can solve the above problem is described below.

FIGS. 4 to 6 are cross-sectional views taken along line A-A′ of FIG. 1 according to an embodiment. FIGS. 4 to 6 are drawings showing only a part of configurations of the light path control member.

Referring to FIG. 4, the light conversion part 300 includes a coating layer 500. Specifically, the coating layer 500 is disposed inside the receiving part 320. Specifically, the coating layer 500 is disposed on an inner surface of the receiving part 320. That is, the coating layer 500 is disposed on a bottom surface and a side surface of the receiving part 320. Accordingly, the coating layer 500 can be in contact with the partition wall part 310 and the base part 350.

The coating layer 500 may include a material having a glass transition temperature (TG, ° C.) of a set range. For example, the coating layer 500 may include a material having a glass transition temperature of 100° C. or higher. In detail, the coating layer 500 may include a material having a glass transition temperature of 200° C. or higher. More specifically, the coating layer 500 may include a material having a glass transition temperature of 100° C. to 300° C.

The coating layer 500 has a glass transition temperature within the above range, and accordingly, the embodiment can prevent a shape of the light conversion part from changing during operation of the light path control member. That is, the coating layer 500 is coated on one surface of the light conversion part 300. Accordingly, the coating layer can fix the shape of the light conversion part. Accordingly, it is possible to prevent the shape of the light conversion part 300 from changing due to heat generated during operation of the light path control member.

The coating layer 500 has a thickness in a set range. In detail, the thickness of the coating layer 500 can be 0.1 μm or more. In more detail, the thickness of the coating layer 500 may be 0.5 um or more. In more detail, the thickness of the coating layer 500 may be 1 um or more. In more detail, the thickness of the coating layer 500 may be 0.1 um to 2 um.

It is difficult to implement a process to form the thickness of the coating layer 500 to be less than 0.1 um. In addition, if the thickness of the coating layer 500 exceeds 2 um, an area of the receiving part 320 may be reduced. That is, a width of the receiving part 320 is reduced by a thickness of the coating layer 500. Accordingly, the light conversion material 300 is not disposed in a sufficient amount inside the receiving part 320. Accordingly, the driving characteristics of the light path control member may be reduced.

The coating layer 500 may include a transparent material. In detail, the coating layer 500 may include a material capable of transmitting light. Accordingly, it is possible to prevent the transmittance of light passing through the receiving part 320 from being reduced by the coating layer 500.

The coating layer 500 may include a resin material. In detail, the resin material has a decomposition temperature and thickness within the above range. For example, the coating layer 500 may include at least one material among parylene, polyethersulfone, poly tetrafluoroethylene, and poly methylmethacrylate.

Since the coating layer 500 is disposed on the bottom surface and inner surface of the receiving part 350, the light conversion material 330 and the partition wall part 310 may be prevented from coming into contact. That is, the coating layer 500 is disposed between the light conversion material 330 and the partition wall part 310 and between the light conversion material 330 and the base part 350. Accordingly, the light conversion material 330 is prevented from directly contacting the partition wall part 310 and the base part 350.

Accordingly, the embodiment can prevent the photo initiator or the additive from flowing into the light conversion material 330. Accordingly, the embodiment can prevent impurities from penetrating into the light conversion material 330. Accordingly, the embodiment can improve the operating characteristics of the light conversion material 330.

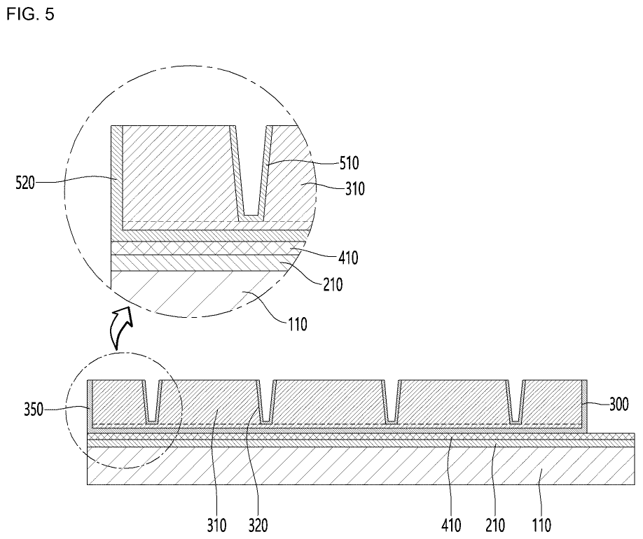

Referring to FIG. 5, the light conversion part 300 includes a coating layer. In detail, the light conversion part 300 includes a first coating layer 510 and a second coating layer 520.

The first coating layer 510 is disposed inside the receiving part 320. The first coating layer 510 can contact the partition wall part 310 and the base part 350 inside the receiving part 320.

The second coating layer 520 is disposed on an outer surface of the light conversion part 300. In detail, the second coating layer 520 is disposed on the outer surface of the light conversion part 330. That is, the second coating layer 520 is disposed on the outer surface of the partition wall part 310 which is disposed at an outermost side among the plurality of partition wall parts 310. In addition, the second coating layer 520 is disposed on a lower surface of the light conversion part 330. In detail, the second coating layer 520 is disposed between the light conversion part 330 and the buffer layer 410.

The first coating layer 510 prevents the light conversion material 330 and the partition wall part 310 from directly contacting each other. Accordingly, the driving characteristics of the light path control member can be improved.

In addition, the second coating layer 520 can maintain the shape of the light path control member. The second coating layer 520 is disposed on the outer surface of the light path control member. The second coating layer 520 has a decomposition temperature within a set range. Therefore, the light path control member does not shrink due to heat generated when the light path control member is driven. The second coating layer 520 is disposed on the outer surface of the light path control member. Accordingly, the shape of the light path control member can be fixed. In addition, the second coating layer 520 has a decomposition temperature within a set range. Therefore, a heat resistance of the light path control member can be improved by the second coating layer.

Therefore, it is possible to prevent the shape of the light conversion part from changing when driving the light path control member. Accordingly, the reliability of the light path control member can be improved.

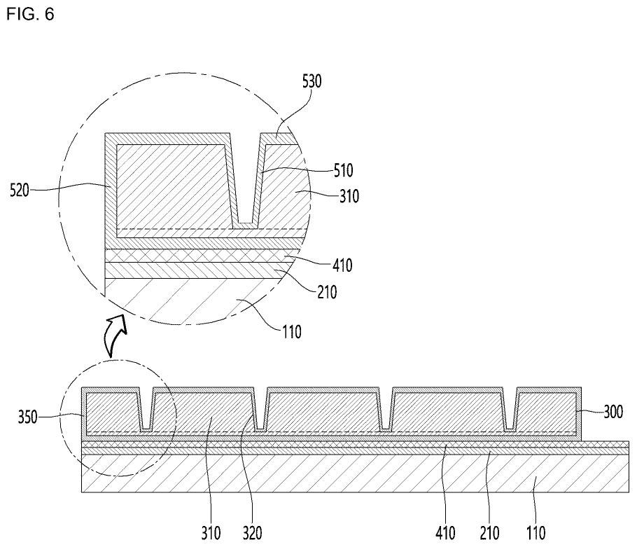

Referring to FIG. 6, the light conversion part 300 includes a coating layer. In detail, the light conversion part 300 includes a first coating layer 510, a second coating layer 520, and a third coating layer 530.

The first coating layer 510 is disposed inside the receiving part 320. The first coating layer 510 contacts the partition wall part 310 and the base part 350 inside the receiving part 320.

The second coating layer 520 is disposed on the outer surface of the light conversion part 300. The second coating layer 520 is disposed on the outer surface of the light conversion part 330.

The third coating layer 530 is disposed on the outer surface of the light conversion part 300. In detail, the third coating layer 530 is disposed on the upper surface of the light conversion part 330. In detail, the third coating layer 520 is disposed on the upper surface of the partition wall part 310.

The third coating layer 530 is connected to at least one of the first coating layer 510 and the second coating layer 520. For example, the third coating layer 530 may be connected to the first coating layer 510 and the second coating layer 520. That is, the first coating layer 510, the second coating layer 520, and the third coating layer 530 may be formed integrally. Accordingly, the first coating layer 510, the second coating layer 520, and the third coating layer 530 may be formed in one process. Therefore, process efficiency can be improved.

It is possible to prevent the light conversion material 330 and the partition wall part 310 from coming into contact with each other by the first coating layer 510. Accordingly, the driving characteristics of the light path control member can be improved.

In addition, the second coating layer 520 can maintain a shape of the light path control member. The second coating layer 520 is disposed on the outer surface of the light path control member. Accordingly, the shape of the light path control member can be fixed. In addition, the second coating layer 520 has a decomposition temperature within a set range. Therefore, the heat resistance of the light path control member can be improved by the second coating layer. Therefore, it is possible to prevent the shape of the light conversion part from changing when driving the light path control member. Therefore, the reliability of the light path control member can be improved.

The adhesion characteristics of the light conversion part 300 and the adhesive layer 420 are improved by the third coating layer 530. The partition wall part 310 and the receiving part 320 are formed through a patterning process. For example, the partition wall part 310 and the receiving part 320 can be formed on the resin layer through an imprinting process. At this time, when a mold and a resin layer are separated, a pinhole may be formed on the upper surface of the partition wall part 310. In addition, the thickness of the partition wall part 310 may become uneven.

The third coating layer 530 is disposed on the upper surface of the partition wall part 310. Accordingly, a surface of the light conversion part that comes into contact with the adhesive layer can be flattened. In addition, a thickness difference between the partition wall parts can be reduced. Therefore, adhesion characteristics of the adhesive layer 420 and the light conversion part 300 can be improved.

Meanwhile, although not shown in the drawing, the third coating layer 530 may include a pattern. For example, a rough pattern having a set range of spacing and height may be formed on the upper surface of the third coating layer 530.

Accordingly, a contact area between the third coating layer 530 and the adhesive layer 420 may increase. Therefore, the adhesion characteristics of the light conversion part 300 and the second electrode 220 may be improved.

In addition, light passing through the third coating layer 530 may be scattered by the rough pattern. Accordingly, the embodiment can prevent light from being transmitted toward the outer surface of the light conversion part. Therefore, the light loss of the light path control member is reduced. Therefore, a brightness of the light path control member may be improved.

The first coating layer 510, the second coating layer 520, and the third coating layer 530 have the same or similar thicknesses. Accordingly, the first coating layer 510, the second coating layer 520, and the third coating layer 530 can be formed in one process. Therefore, the process efficiency of the light path control member can be improved.

Alternatively, the first coating layer 510, the second coating layer 520, and the third coating layer 530 can be disposed with different thicknesses. For example, the thickness of the second coating layer 520 can be greater than the thickness of at least one of the first coating layer 510 and the third coating layer 530.

The second coating layer 520 is disposed on the outer surface of the light conversion part 300. The thickness of the second coating layer 520 can be formed to be greater than the thicknesses of the other coating layers. Accordingly, an overall shape of the light conversion part can be maintained by the second coating layer 520. In addition, a change in a shape of the light conversion part can be prevented.

In addition, the thicknesses of the first coating layer 510 and the third coating layer are formed to be relatively small. Accordingly, the embodiment can prevent the size inside the receiving part 310 from being reduced by the first coating layer 510. Accordingly, the embodiment can prevent the driving characteristics of the light path control member from being decreased. In addition, the embodiment can prevent the thickness of the light path control member from increasing by the third coating layer 530.

The light path control member according to the embodiment includes a coating layer. In detail, the light path control member according to the embodiment includes at least one coating layer among a first coating layer, a second coating layer, and a third coating layer.

The light path control member can prevent a decrease in driving characteristics by the coating layer. A light conversion material and a partition wall part do not come into direct contact by the coating layer. In addition, the light conversion material and a base part do not come into direct contact by the coating layer. Therefore, impurities of the partition wall part or the base part do not flow into the light conversion material.

In addition, a reliability of the light path control member is improved by the coating layer. The coating layer has a thickness and a decomposition temperature within a set range. Accordingly, a shape of the light path control member can be fixed by the coating layer. Therefore, a shape of the light conversion part does not change due to heat generated during driving of the light path control member.

In addition, adhesion characteristics of the second electrode and the light conversion part are improved by the coating layer. That is, a surface of the light conversion part in contact with the adhesive layer is flattened. In addition, an area of the coating layer in contact with the adhesive layer is increased. Accordingly, the adhesive characteristics of the adhesive layer are improved.

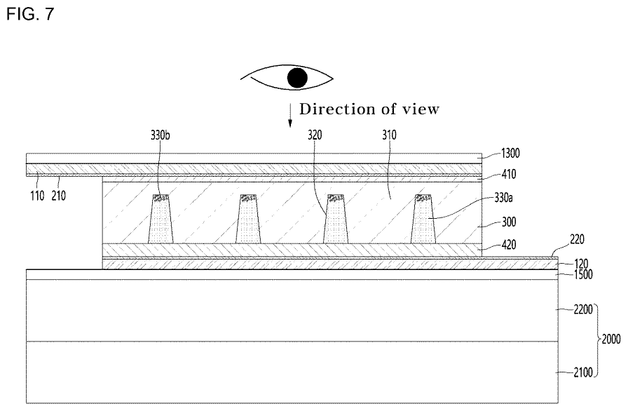

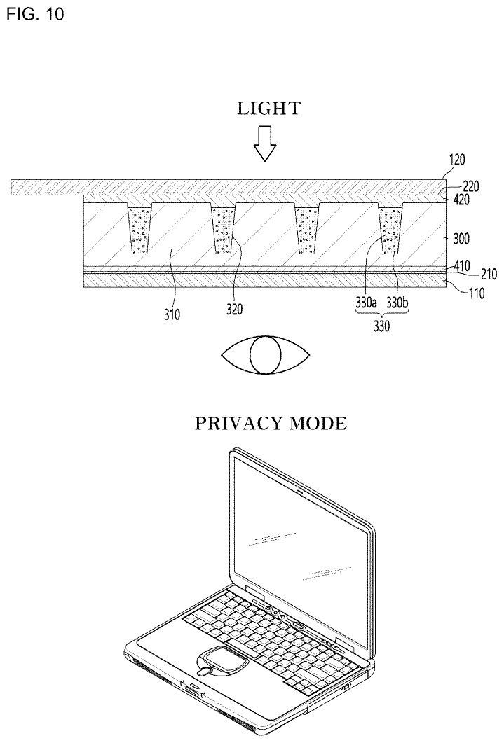

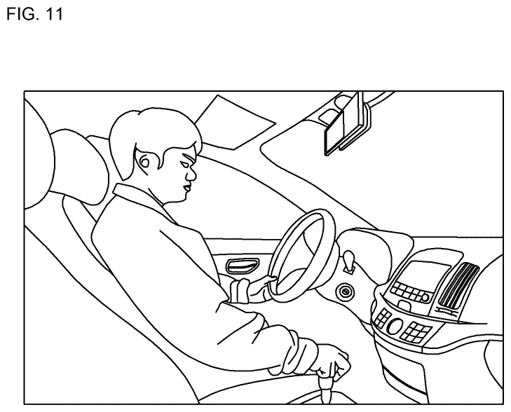

Hereinafter, a display device and a display device to which a light path control member according to an embodiment is applied will be described with reference to FIGS. 7 to 11.

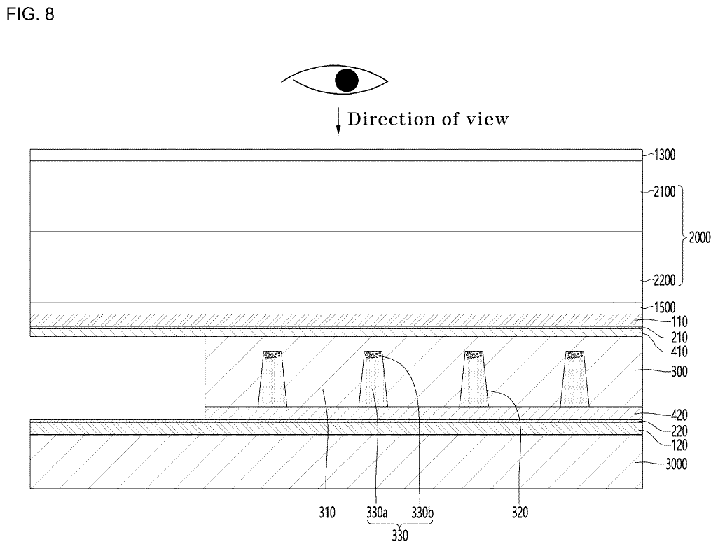

Referring to FIGS. 7 and 8, the light path control member 1000 according to the embodiment may be disposed on or below the display panel 2000.

The display panel 2000 and the light path control member 1000 may be disposed to be adhered to each other. For example, the display panel 2000 and the light path control member 1000 may be adhered to each other via an adhesive member 1500. The adhesive member 1500 may be transparent. For example, the adhesive member 1500 may include an adhesive or an adhesive layer including a light transparent adhesive material.

The adhesive member 1500 may include a release film. In detail, when adhering the light path control member and the display panel, the release film is removed. Accordingly, the light path control member and the display panel may be adhered.

The display panel 2000 may include a first base substrate 2100 and a second base substrate 2200. When the display panel 2000 is a liquid crystal display panel, the light path control member may be formed under the liquid crystal panel. That is, when a surface viewed by the user in the liquid crystal panel is defined as an upper portion of the liquid crystal panel, the light path control member may be disposed under the liquid crystal panel. The display panel 2000 may be formed in a structure in which the first base substrate 2100 including a thin film transistor (TFT) and a pixel electrode and the second base substrate 2200 including color filter layers are bonded to each other with a liquid crystal layer interposed therebetween.

In addition, the display panel 2000 may be a liquid crystal display panel of a color filter on transistor (COT) structure in which a thin film transistor, a color filter, and a black electrolyte are formed at the first base substrate 2100 and the second base substrate 2200 is bonded to the first base substrate 2100 with the liquid crystal layer interposed therebetween. That is, a thin film transistor may be formed on the first base substrate 2100, a protective film may be formed on the thin film transistor, and a color filter layer may be formed on the protective film. In addition, a pixel electrode in contact with the thin film transistor may be formed on the first base substrate 2100. At this point, in order to improve an aperture ratio and simplify a masking process, the black electrolyte may be omitted, and a common electrode may be formed to function as the black electrolyte.

In addition, when the display panel 2000 is the liquid crystal display panel, the display device may further include a backlight unit 3000 providing light from a rear surface of the display panel 2000.

That is, as shown in FIG. 8, the light path control member may be disposed under the liquid crystal panel and on the backlight unit 3000, and the light path control member may be disposed between the backlight unit 3000 and the display panel 2000.

Alternatively, as shown in FIG. 7, when the display panel 2000 is an organic light emitting diode panel, the light path control member may be formed on the organic light emitting diode panel. That is, when the surface viewed by the user in the organic light emitting diode panel is defined as an upper portion of the organic light emitting diode panel, the light path control member may be disposed on the organic light emitting diode panel. The display panel 2000 may include a self-luminous element that does not require a separate light source. In the display panel 2000, a thin film transistor may be formed on the first base substrate 2100, and an organic light emitting element in contact with the thin film transistor may be formed. The organic light emitting element may include an anode, a cathode, and an organic light emitting layer formed between the anode and the cathode. In addition, the second base substrate 2200 configured to function as an encapsulation substrate for encapsulation may be further included on the organic light emitting element.

That is, light emitted from the display panel 2000 or the backlight unit 3000 can move from the second substrate 120 of the light path control member toward the first substrate 110.

In addition, although not shown in drawings, a polarizing plate may be further disposed between the light path control member 1000 and the display panel 2000. The polarizing plate may be a linear polarizing plate or an external light reflection preventive polarizing plate. For example, when the display panel 2000 is a liquid crystal display panel, the polarizing plate may be a linear polarizing plate. Further, when the display panel 2000 is the organic light emitting diode panel, the polarizing plate may be an external light reflection preventing polarizing plate.

In addition, an additional functional layer 1300 such as an anti-reflection layer, an anti-glare, or the like may be further disposed on the light path control member 1000. Specifically, the functional layer 1300 may be adhered to one surface of the first substrate 110 of the light path control member. Although not shown in drawings, the functional layer 1300 may be adhered to the first substrate 110 of the light path control member via an adhesive layer. In addition, a release film for protecting the functional layer may be further disposed on the functional layer 1300.

Further, a touch panel may be further disposed between the display panel and the light path control member.

It is shown in the drawings that the light path control member is disposed at an upper portion of the display panel, but the embodiment is not limited thereto, and the light path control member may be disposed at various positions such as a position in which light is adjustable, that is, a lower portion of the display panel, or between a second substrate and a first substrate of the display panel, or the like.

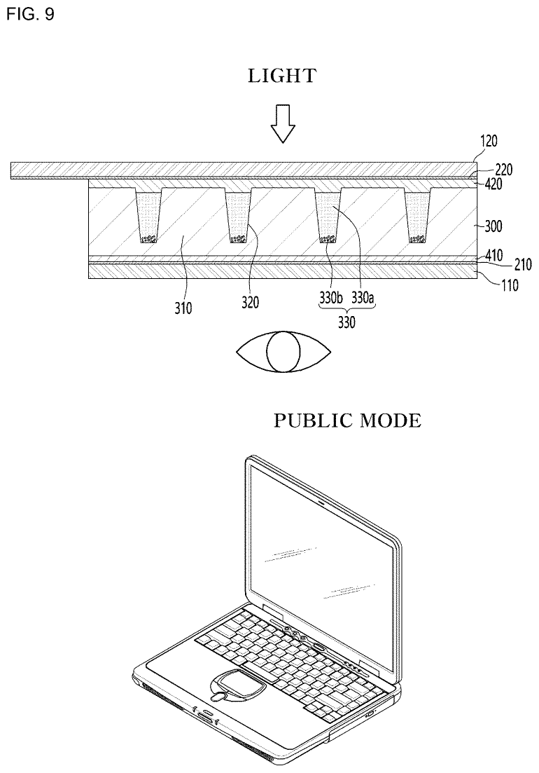

Referring to FIGS. 9 to 11, the light path control member according to the embodiment may be applied to a display device that displays a display.

Referring to FIGS. 9 to 11, the light path control member according to an embodiment may be applied to a display device that displays a display.

For example, when power is applied to the light path control member as shown in FIG. 9, the receiving part functions as the light transmitting part, so that the display device may be driven in the public mode, and when power is not applied to the light path control member as shown in FIG. 9, the receiving part functions as the light blocking part, so that the display device may be driven in the light blocking mode.

Accordingly, a user may easily drive the display device in a privacy mode or a normal mode according to application of power.

Light emitted from the backlight part or the self-luminous element may move from the first substrate toward the second substrate. Alternatively, the light emitted from the backlight part or the self-luminous element may also move from the second substrate toward the first substrate.

In addition, referring to FIG. 11, the display device to which the light path control member according to the embodiment is applied may also be applied inside a vehicle.

For example, the display device including the light path control member according to the embodiment may display a video confirming information of the vehicle and a movement route of the vehicle. The display device may be disposed between a driver seat and a passenger seat of the vehicle.

In addition, the light path control member according to the embodiment may be applied to a dashboard that displays a speed, an engine, an alarm signal, and the like of the vehicle.

Further, the light path control member according to the embodiment may be applied to a front glass (FG) of the vehicle or right and left window glasses.

The characteristics, structures, effects, and the like described in the above-described embodiments are included in at least one embodiment of the present invention, but are not limited to only one embodiment. Furthermore, the characteristic, structure, and effect illustrated in each embodiment may be combined or modified for other embodiments by a person skilled in the art. Accordingly, it is to be understood that such combination and modification are included in the scope of the present invention.

In addition, embodiments are mostly described above, but the embodiments are merely examples and do not limit the present invention, and a person skilled in the art may appreciate that several variations and applications not presented above may be made without departing from the essential characteristic of embodiments. For example, each component specifically represented in the embodiments may be varied. In addition, it should be construed that differences related to such a variation and such an application are included in the scope of the present invention defined in the following claims.

1. A light path control member comprising:
a first substrate;
a first electrode disposed on the first substrate;
a second substrate disposed on the first substrate;
a second electrode disposed under the second substrate;
a light conversion part disposed between the first electrode and the second electrode; and
a coating layer disposed on surfaces of the light conversion part,
wherein the light conversion part includes a partition wall part and a receiving part that are alternately disposed,
wherein a light conversion material is disposed inside the receiving part, and
wherein the coating layer includes:
a first coating layer disposed on an inner surface of the receiving part, and
a second coating layer disposed on an outer surface of the light conversion part.

2. The light path control member of claim 1, wherein the first coating layer is disposed on a bottom surface and an inner side surface of the receiving part.

3. The light path control member of claim 1, wherein the first coating layer includes a material having a glass transition temperature of 100° C. or higher.

4. The light path control member of claim 1, wherein the first coating layer is disposed to a thickness of 0.1 μm to 2 μm.

5. The light path control member of claim 1, wherein a thickness of the second coating layer is different from a thickness of the first coating layer.

6. The light path control member of claim 1, wherein the second coating layer is disposed on the outer surface of the light conversion part and a lower surface of the light conversion part.

7. The light path control member of claim 5, further comprising:
a third coating layer disposed on an upper surface of the partition wall part.

8. The light path control member of claim 7, wherein the first coating layer, the second coating layer, and the third coating layer are formed integrally.

9. The light path control member of claim 7, wherein a thickness of the second coating layer is different from a thickness of at least one of the first coating layer and the third coating layer.

10. The light path control member of claim 9, wherein the thickness of the second coating layer is greater than the thickness of the first coating layer.

11. The light path control member of claim 9, wherein the thickness of the second coating layer is greater than the thickness of the third coating layer.

12. The light path control member of claim 1, wherein an inner side surface of the receiving part has an incline with respect to a bottom surface of the receiving part, and wherein the first coating layer has an incline corresponding to the incline of the inner side surface of the receiving part.

13. A light path control member comprising:
a first substrate;
a first electrode disposed on the first substrate;
a second substrate disposed on the first substrate;
a second electrode disposed under the second substrate;
a light conversion part disposed between the first electrode and the second electrode; and
a coating layer coated on surfaces of the light conversion part,
wherein the coating layer includes a material having a glass transition temperature of 100° C. or higher.

14. The light path control member of claim 13, wherein the coating layer includes a first portion disposed on an outer surface of the optical conversion part.

15. The light path control member of claim 13, wherein the optical conversion part includes a partition wall part and a receiving part that are alternately disposed, and wherein the coating layer includes a second portion disposed on a bottom surface of the receiving part and an inner side surface of the receiving part.

16. The light path control member of claim 15, wherein the coating layer includes a third portion disposed on an upper surface of the partition wall part.

17. The light path control member of claim 16, wherein a thickness of the first portion is different from at least one of a thickness of the second portion and a thickness of the third portion.

18. The light path control member of claim 17, wherein the thickness of the first portion is greater than the thickness of the second portion.

19. The light path control member of claim 18, wherein the thickness of the first portion is greater than the thickness of the third portion.

20. The light path control member of claim 19, wherein the thickness of the second portion is same as the thickness of the third portion.
